(19) United States
(12) Patent Application Publication
(10) Pub. No.: US 2023/0342730 A1
(43) Pub. Date: Oct. 26, 2023

(54) IMAGE RECOGNITION, DATA PROCESSING, AND DATA ANALYTICS SYSTEM

(71) Applicants: Jonathan Cabak, Plymouth, MN (US); Nathan Oelke, Minneapolis, MN (US)

(72) Inventors: Jonathan Cabak, Plymouth, MN (US); Nathan Oelke, Minneapolis, MN (US)

(21) Appl. No.: 18/306,748

(22) Filed: Apr. 25, 2023

Related U.S. Application Data
(60) Provisional application No. 63/334,300, filed on Apr. 25, 2022.

(51) Int. Cl. G06Q 10/20; G06V 10/82; G06V 20/52; G06T 11/20

(52) U.S. Cl. CPC G06Q 10/20; G06V 10/82; G06V 20/52; G06T 11/206

(57) ABSTRACT

An image processing system comprises a processor operable to apply a mathematical model to objects of an image to determine/predict a pattern that can be correlated to a particular object. The system is operational to create and store a vehicle inspection, repair, and maintenance record comprising the correlated pattern, unique identifier, the image, the particular object, or any combination thereof. The system is also operational to generate a visualization comprising business intelligence, analytics, or both using the stored vehicle inspection, repair, and maintenance record.

### CROSS REFERENCE TO RELATED APPLICATION

This application claims priority to U.S. Provisional Application No. 63/334,300, filed Apr. 25, 2022, the contents of which are incorporated herein by reference.

### BACKGROUND

The field of invention relates to image recognition or understanding and data processing and, more particularly, artificial intelligence used for image recognition or understanding and data analytics.

The relevant art relates to auto repair shop software solutions. The auto repair business is a multi-billion dollar a year business. The reputation of an auto repair shop is critical for success, and a primary factor that can affect a shop's reputation is customer satisfaction. Important performance measures that can affect customer satisfaction are cost of repairs, repair time, and quality of work.

State of the art auto repair shop software solutions can be used to automate tasks, such as data entry, track customers, and vehicle repair histories. Although these systems can assist with some operations management, they lack certain features that could be used to reduce repair costs and improve repair time and quality of work.

As can be seen, there is a need for an auto repair shop software solution that can improve customer satisfaction.

### BRIEF DESCRIPTION OF THE DRAWINGS

The features and advantages of the present invention will become more apparent from the detailed description set forth below when taken in conjunction with the following drawings.

FIG. 1 is an image recognition, data processing, and data analytics system, according to an exemplary embodiment.

FIG. 2 is a flow diagram of a computer algorithm illustrating the steps for object recognition, data processing, and data analytics, according to an exemplary embodiment.

FIG. 3 is a block diagram of a general and/or special purpose computer, which may be a general and/or special purpose computing device, in accordance with some of the example embodiments of the invention.

### DETAILED DESCRIPTION

The following detailed description is of the best currently contemplated modes of carrying out exemplary embodiments of the invention. The description is not to be taken in a limiting sense but is made merely for the purpose of illustrating the general principles of the present invention.

As previously stated in the background, prior art auto repair shop software solutions lack certain features necessary to improve customer satisfaction.

Problems that prior art auto repair shop software solutions fail to address are costs and quality of work product that can be affected by unscrupulous behavior of personnel. Bad actors permeate most businesses and auto repair is no exception. For a skilled mechanic, it is easy, and not uncommon, to make unnecessary repairs, replace parts with inferior parts, or make repairs using old or cheap parts. The motivation for such activities should be obvious, to make extra money. However, not only are these activities fraudulent, but they increase costs and negatively affect customer satisfaction. Further, vehicles that are not properly repaired present a danger to their operators and the public.

Additionally, auto repair shop software solutions that maintain historical records of repairs rely on manual entry or other means that are susceptible to nefarious acts by bad actors that wish to change the historical records for financial gain.

Presented herein is a data imaging processing system, and methods of use, that applies a mathematical model to a digital image of an automobile, a component part thereof, a service technician, or any combination thereof, to determine a pattern or predict a pattern that can be correlated to an identifier unique to the automobile, the component part thereof, or the service technician. The correlated pattern, unique identifier, the digital image, or any combination thereof, can be assigned to a vehicle inspection, repair, and maintenance record and stored for historical reference.

In an embodiment, data image processing system comprises a MobileDet architecture for mobile accelerators (object detection model for mobile accelerators); See Y. Xiong et al., “MobileDets: Searching for Object Detection Architectures for Mobile Accelerators,” 2021 IEEE/CVF Conference on Computer Vision and Pattern Recognition (CVPR), Nashville, TN, USA, 2021, pp. 3824-3833, doi: 10.1109/CVPR46437.2021.00382.

In another embodiment, the digital image processing system comprises one or more imaging devices and one or more sensing devices. The devices can include digital camera(s), infrared sensor(s), motion detector(s), laser(s), and LIDAR sensing device(s). The sensing devices can be used to complement the mathematical model in determining unique identifiers or as a substitute mechanism in determining unique identifiers for automobiles, component parts thereof, or service technicians.

In another embodiment, the mathematical model can be a trained model that comprises a parameter space trained using a dataset of generally related images, Common Objects in Context (COCO), auto repair shop specific related images, or both. The mathematical model can be trained using supervised, semi-supervised, or unsupervised learning methods and Artificial Intelligence (AI) based mathematical models, such as deep learning or convolutional neural networks.

In another embodiment, the mathematical model comprises a single shot object detection network, region-based convolutional network (RCNN), image segmentation network, histogram of oriented gradients network, or a You Only Look Once (YOLO) network.

In yet another embodiment, an AI based model with a parameter space trained using generally related images can be further trained by adapting the parameter space based on an auto repair dataset, automotive repair, maintenance, and management principles, or both. Alternatively, the AI based model could be trained to have a parameter space trained using an auto repair dataset, automotive repair, maintenance, and management principles, or both.

In another embodiment, digital images captured, and information sensed during an auto repair shop's service hours can be stored as an auto repair shop dataset that can be used for training purposes. Additionally, captured digital images can be evaluated, images classified, image objects classified and catalogued, and stored as a tagged auto repair shop dataset.

In another embodiment, the identifier unique to the automobile is a license plate number, a vehicle identification number, a barcode, a QR code, information from a vehicle registration sticker, or any combination thereof. The identifier unique to a component part of the vehicle can be a part number, or partial part number, for any part worked on or removed during service. The identifier unique to the service technician can be a service technician identifier.

In another embodiment, a service order is assigned to the vehicle inspection, repair, and maintenance record. The service order can include one or more service requests, parts list, service technician identifier, and customer information.

In yet another embodiment, the digital image includes a shop identifier, such as, a watermark, a geotag, or both, that identifies an auto repair shop, date and time, and location. In still yet another embodiment, the system generates a shop identifier for each digital image. The shop identifier can be added to the vehicle inspection, repair, and maintenance record. In yet another embodiment, the system generates one or more work order items and adds one or more work order items to the vehicle inspection, repair, and maintenance record.

The term correlate, as used herein, refers to processes, such as comparing, data to determine if data variables share the same or similar values. Similar in this context may refer to values that fall within a range of one another, have similar scores, or scores within an acceptable range of a target score. Variable, in this context, refers to parameters and value pairs. Parameters can also be referred to as meta data. Objects, as used herein, can include one or more digital representations acquired from processing an image. The term event, as used herein, can refer to an automobile entering a stall or bay of an auto repair shop or any activity that may occur therein by a customer, a service technician, or anyone in the bay.

### System

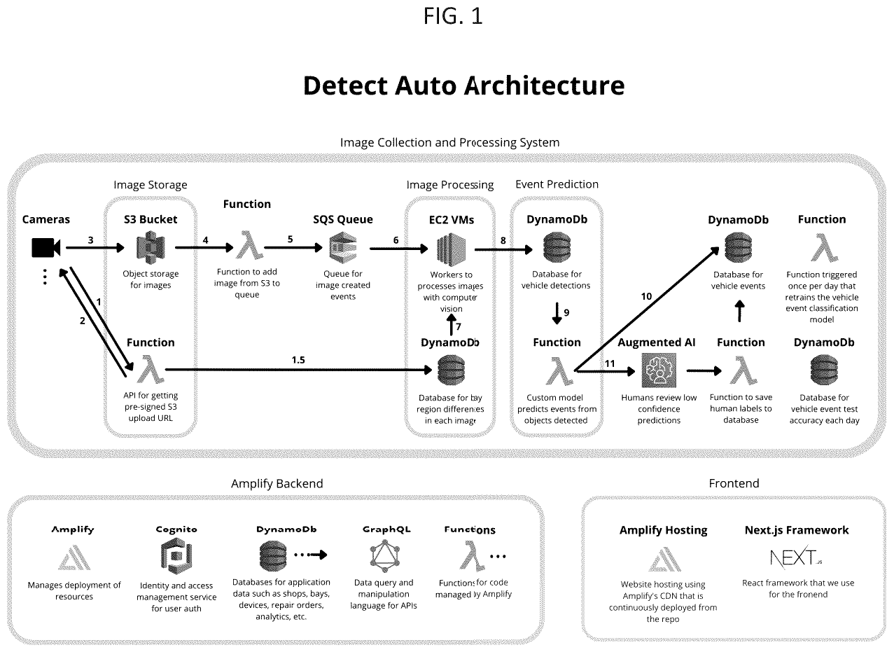

FIG. 1 is an image recognition, data processing, and data analytics system 100, according to an exemplary embodiment. System 100 comprises an image and data processing system 102 and visualization system 104. Image and data processing system 102 comprises an image storage device 102, an image processing device 104, an event prediction device 106, and an events database 108. Visualization system 104 comprises a visualization server 110 and configured charts, graphs, spreadsheets, or any combination thereof.

Image storage device 102 comprises one or more trained mathematical models, data from images captured from cameras, imaging devices, or both, encoded data from emitting devices, and preloaded data.

The preloaded data can include metadata, tables of service orders, encoded identifiers, and tables of test data. The test data can be big data and include various image objects, scores, or both. The encoded identifiers can include identifiers unique to automobiles, component parts thereof, or service technicians and other information relevant to events. The test data can include object identifiers unique to automobiles, component parts thereof, or service technicians and other information relevant to events. The identifiers in the test data can be established a priori, empirically, or both.

Image processing device 104 prepares the data for further processing. Data preparation can include removing duplicate variables, filtering unwanted outlying variables, fixing structural errors, fixing missing data, and validating. Data preparation can be performed using defined classes, categories, and rules.

Event prediction device 106 processes the prepped data and determines patterns, predicts patterns, or both, in images using one or more of the trained mathematical models. Event prediction device 106 correlates determined patterns, scores, or both, with images, patterns of images, patterns of image objects, scores, or any combination thereof.

Event prediction device 106 can process the prepped data, or unprepped data, and determine a pattern without using the trained mathematical model. In this case, the unique identifier used to identify automobiles, component parts thereof, or service technicians is encoded in sensed data transmitted by an emitting device.

The events database stores the correlated pattern, unique identifier, the digital image, image objects, datasets from test data, metadata, scores, or any combination thereof. The stored data can be assigned to a vehicle inspection, repair, and maintenance record and stored for historical reference.

Visualization server 110 can populate the configured charts, graphs, spreadsheets, or any combination thereof, with correlated patterns, unique identifiers, digital images, image objects, datasets from test data, metadata, scores, or any combination thereof, for the purpose of viewing business intelligence, statistics, training, making improvements to test data, or both.

### Process

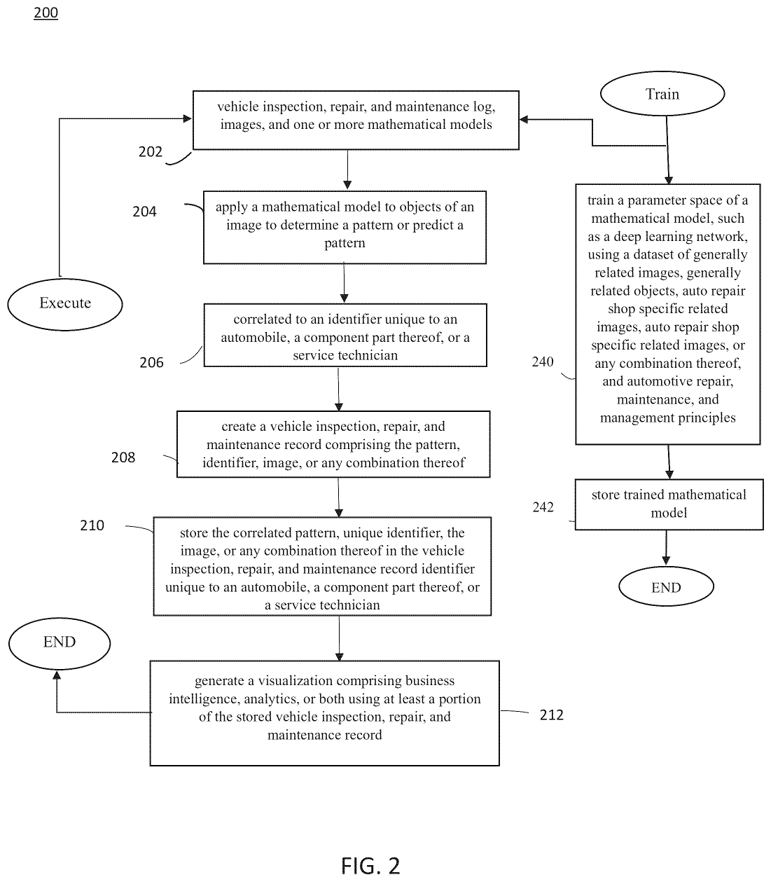

FIG. 2 is a flow diagram of a computer algorithm illustrating the steps for recognizing or understanding objects, data processing, and data analytics, according to an exemplary embodiment. Algorithm 200 can be executed manually or automatically using a sensor, e.g., a motion sensor, or a comparison of pixel changes from one image to another indicating motion, triggered when a vehicle passes in range or at the time images are captured. At block 202, algorithm 200 performs an operation to update storage, such as cache memory, swap, virtual memory, mass storage, cloud storage, or any combination thereof, objects of the images captured.

At block 204, algorithm 204 applies a mathematical model to objects of an image in storage, such as cache, virtual memory, or cloud storage, to determine a pattern or predict a pattern. At block 206, algorithm 200 correlates an identifier unique to an automobile, a component part thereof, or a service technician using the determined or predicted pattern. At block 208, algorithm 200 creates a vehicle inspection, repair, and maintenance record comprising the correlated pattern, unique identifier, the image, or any combination thereof. At block 210, algorithm 200 stores the correlated pattern, unique identifier, the image, or any combination thereof in the vehicle inspection, repair, and maintenance record. At block 210, algorithm 200 generates a visualization comprising business intelligence, analytics, or both using at least a portion of the stored vehicle inspection, repair, and maintenance record.

In another embodiment, algorithm 200, at block 206, correlates encoded data from a sensor to identify information associated with the automobile, the component part thereof, or the service technician and correlates either independent of or dependent with correlation using the pattern.

In yet another embodiment, algorithm 200, at block 210, stores a service order to the vehicle inspection, repair, and maintenance record, the service order including one or more service requests, parts list, service technician identifier, and customer information.

In still yet another embodiment, algorithm 200, at block 210, assigns a shop identifier, such as, a watermark, a geotag, or both, that identifies an auto repair shop, date and time, and location to the vehicle inspection, repair, and maintenance record. At block 210, algorithm 200 can store the service order and the shop identifier in the vehicle inspection, repair, and maintenance record.

According to still another embodiment, algorithm 200 can be executed to train a mathematical model from a raw state or further train a mathematical model that has already been trained. At block 240, algorithm 200 trains a parameter space of a mathematical algorithm (raw) or an existing model, such as a deep learning network algorithm or model, using a dataset of generally related images, generally related objects, auto repair shop specific related images, auto repair shop specific related images, automotive repair, maintenance, and management principles, or any combination thereof.

Algorithm 200 can be terminated manually or by any designated trigger, such as after a model has been trained, tested, and validated or based on a timer.

### Use Case

An auto repair shop may comprise an administrative service area and a mechanical service area. The administrative service area may comprise various tools to allow a service technician to perform administrative tasks such as opening and completing service order forms. The mechanical service area may comprise one or more bay doors, one or more bay service stalls, one or more mechanical lifts, service tools, service parts, and customer and technician entrance areas. The mechanical service area is where vehicle inspection, repairs, and services are performed.

Cameras 10 and sensing devices 20 can be strategically mounted throughout an auto repair shop service area. One or more computers configured as servers can be communicably coupled to the cameras 10 and sensing devices 20 using a wired or wireless network. The servers can include one or more installations of image recognition, data processing, and data analytics system 100.

Cameras 10 can be configured to capture images as an automobile enters a bay, at regular time intervals as repairs are being performed, when a technician enters the bay, or other similar events. Cameras 10 can be configured to record images continuously through a set date and time, e.g., Mondays-Saturdays, each day of the year, except for specified holidays, and during business service hours. Sensing devices 20 can automatically receive encoded data, including identifiers, when in range of an emitting device 30 and may be always on.

Image recognition, data processing, and data analytics system 100 can be triggered into operation in response to captured images or operated continuously to monitor changes in memory, e.g., camera memory or camera image storage memory. Image recognition, data processing, and data analytics system 100 can determine the amount of time a vehicle is in a repair bay. Image recognition, data processing, and data analytics system 100 can detect the precise moment in time that a vehicle or person enters a targeted region in an administrative and mechanical service area.

When a vehicle or person is first detected entering a service area, image recognition, data processing, and data analytics system 100 can create table entry records that can list, e.g., the events performed during service, the vehicle the events were performed on, the service area the events were performed in, the technician or technicians performing the events, and the amount of time needed to complete the events.

Image recognition, data processing, and data analytics system 100 can use the table entry records to create various statistics and business intelligence reports, graphs, charts, and their visual representations. The reports, graphs, and charts are useful in improving business operations and improving customer satisfaction.

### Example Computer-Readable Medium Implementations

The example embodiments described above such as, for example, the systems and procedures depicted in or discussed in connection with FIGS. 1-4 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

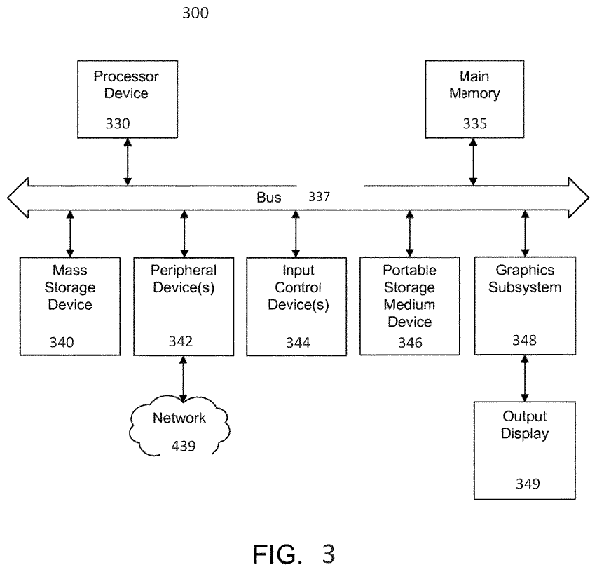

FIG. 3 is a block diagram of a general and/or special purpose computer 300, which may be a general and/or special purpose computing device, in accordance with some of the example embodiments of the invention. The computer 300 may be, for example, a user device, a user computer, a client computer and/or a server computer, among other things.

The computer 300 may include without limitation a processor device 330, a main memory 335, and an interconnect bus 337. The processor device 330 may include without limitation a single microprocessor or may include a plurality of microprocessors for configuring the computer 300 as a multi-processor system. The main memory 335 stores, among other things, instructions and/or data for execution by the processor device 330. The main memory 335 may include banks of dynamic random-access memory (DRAM), as well as cache memory.

The computer 300 may further include a mass storage device 340, peripheral device(s) 342, portable non-transitory storage medium device(s) 346, input control device(s) 344, a graphics subsystem 348, and/or an output display 349. For explanatory purposes, all components in the computer 300 are shown in FIG. 3 as being coupled via the bus 337. However, the computer 300 is not so limited. Devices of the computer 300 may be coupled via one or more data transport means. For example, the processor device 330 and/or the main memory 335 may be coupled via a local microprocessor bus. The mass storage device 340, peripheral device(s) 342, portable storage medium device(s) 346, and/or graphics subsystem 348 may be coupled via one or more input/output (I/O) buses. The mass storage device 340 may be a nonvolatile storage device for storing data and/or instructions for use by the processor device 330. The mass storage device 340 may be implemented, for example, with a magnetic disk drive or an optical disk drive. In a software embodiment, the mass storage device 340 is configured for loading contents of the mass storage device 340 into the main memory 335.

The portable storage medium device 346 operates in conjunction with a nonvolatile portable storage medium, such as, for example, a compact disc read only memory (CD-ROM), to input and output data and code to and from the computer 300. In some embodiments, the software for storing information may be stored on a portable storage medium and may be inputted into the computer 300 via the portable storage medium device 346. The peripheral device(s) 342 may include any type of computer support device, such as, for example, an input/output (I/O) interface configured to add additional functionality to the computer 300. For example, the peripheral device(s) 342 may include a network interface card for interfacing the computer 300 with a network 439.

The input control device(s) 344 provides a portion of the user interface for a user of the computer 300. The input control device(s) 344 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 300 may include the graphics subsystem 348 and the output display 349. The output display 349 may include a cathode ray tube (CRT) display and/or a liquid crystal display (LCD). The graphics subsystem 348 receives textual and graphical information and processes the information for output to the output display 349.

Each component of the computer 300 may represent a broad category of a computer component of a general and/or special purpose computer. Components of the computer 300 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, cloud data storage, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

The above-disclosed embodiments have been presented for the purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence or combined into a single step/process. The scope of the claims is intended to broadly cover the disclosed embodiments and any such modification. Further, the following clauses represent additional embodiments of the disclosure and should be considered within the scope of the disclosure:

Clause 1, an image processing system for identifying image objects and generating visualizations used for managing auto repair shop processes, comprising: at least one storage device operable to store a vehicle inspection, repair, and maintenance log, images, and one or more mathematical models; and a processor communicatively coupled to the storage device, the processor being operable to perform operations comprising: applying a mathematical model to objects of an image to determine a pattern or predict a pattern that can be correlated to an identifier unique to an automobile, a component part thereof, or a service technician; creating a vehicle inspection, repair, and maintenance record comprising the correlated pattern, unique identifier, the image, or any combination thereof; storing the correlated pattern, unique identifier, the image, or any combination thereof in the vehicle inspection, repair, and maintenance record; and generating a visualization comprising business intelligence, analytics, or both using at least a portion of the stored vehicle inspection, repair, and maintenance record.

Clause 2, the image processing system of clause 1, further comprising an object detection model for mobile accelerators.

Clause 3, the image processing system of any of clause 1-2, further comprising one or more sensing devices used to determine information unique to the automobile, the component part thereof, or the service technician.

Clause 4, the image processing system of any of clauses 1-3, wherein the mathematical model comprises a parameter space trained using a dataset of generally related images, generally related objects, auto repair shop specific related images, auto repair shop specific related images, or any combination thereof, and automotive repair, maintenance, and management principles.

Clause 5, the image processing system of any of clauses 1-4, wherein the mathematical model comprises a deep learning network or a convolutional neural network.

Clause 6, the image processing system of any of clauses 1-5, wherein the processor is further operable to perform operations comprising applying a mathematical model to the objects to detect a license plate number, a vehicle identification number, a barcode, a QR code, information from a vehicle registration sticker, a part number, or partial part number, a service technician identifier, or any combination thereof.

Clause 7, the image processing system of any of clauses 1-6, wherein the processor is further operable to perform operations comprising: assigning a service order to the vehicle inspection, repair, and maintenance record, the service order including one or more service requests, parts list, service technician identifier, and customer information; assigning a shop identifier, such as, a watermark, a geotag, or both, that identifies an auto repair shop, date and time, and location to the vehicle inspection, repair, and maintenance record; and storing the service order and the shop identifier in the vehicle inspection, repair, and maintenance record.

Clause 8, a method of image processing to generate visualizations used for managing auto repair shop processes, comprising: by one or more computing devices: storing a vehicle inspection, repair, and maintenance log, images, and one or more mathematical models; applying a mathematical model to objects of an image to determine a pattern or predict a pattern that can be correlated to an identifier unique to an automobile, a component part thereof, or a service technician; creating a vehicle inspection, repair, and maintenance record comprising the correlated pattern, unique identifier, the image, or any combination thereof; storing the correlated pattern, unique identifier, the image, or any combination thereof in the vehicle inspection, repair, and maintenance record; and generating a visualization comprising business intelligence, analytics, or both using at least a portion of the stored vehicle inspection, repair, and maintenance record.

Clause 9, the method of any of the clauses 1-8, wherein the mathematical model comprises a parameter space trained using a dataset of generally related images, generally related objects, auto repair shop specific related images, auto repair shop specific related images, or any combination thereof, and automotive repair, maintenance, and management principles.

Clause 10, the method of any of the clauses 1-9, wherein the mathematical model comprises a deep learning network or a convolutional neural network.

Clauses 11, the method of any of the clauses 1-10, further comprising applying a mathematical model to an image to detect a license plate number, a vehicle identification number, information from a barcode, information from a QR code, information from a vehicle registration sticker, a part number, or partial part number, a service technician identifier, or any combination thereof.

Clause 12, the method of any of clauses 1-11, further comprising sensing encoded data and correlating the encoded data to identification information associated with the automobile, the component part thereof, or the service technician.

Clause 13, the method of any of clauses 1-12, further comprising: assigning a service order to the vehicle inspection, repair, and maintenance record, the service order including one or more service requests, parts list, service technician identifier, and customer information; assigning a shop identifier, such as, a watermark, a geotag, or both, that identifies an auto repair shop, date and time, and location to the vehicle inspection, repair, and maintenance record; and storing the service order and the shop identifier in the vehicle inspection, repair, and maintenance record.

Clause 14, a non-transitory computer-readable medium storing instructions that, when executed by one or more computing devices, cause the one or more computing devices to perform operations, the operations comprising: storing a vehicle inspection, repair, and maintenance log, images, and one or more mathematical models; applying a mathematical model to objects of an image to determine a pattern or predict a pattern that can be correlated to an identifier unique to an automobile, a component part thereof, or a service technician; creating a vehicle inspection, repair, and maintenance record comprising the correlated pattern, unique identifier, the digital image, or any combination thereof; storing the correlated pattern, unique identifier, the digital image, or any combination thereof in the vehicle inspection, repair, and maintenance record; and generating a visualization comprising business intelligence, analytics, or both using at least a portion of the stored vehicle inspection, repair, and maintenance record.

Clause 15, the non-transitory computer-readable medium of any of clauses 1-14, wherein the mathematical model comprises an object detection model for mobile accelerators.

Clause 16, the non-transitory computer-readable medium of any of clauses 1-15 further comprising sensing encoded data and correlating the encoded data to identification information associated with the automobile, the component part thereof, or the service technician.

Clause 17, the non-transitory computer-readable medium of any of clauses 1-16, further comprising training the mathematical model using a dataset of generally related images, generally related objects, auto repair shop specific related images, auto repair shop specific related images, or any combination thereof, and automotive repair, maintenance, and management principles.

Clause 18, the non-transitory computer-readable medium of any of clauses 1-17, wherein the mathematical model comprises a deep learning network or a convolutional neural network.

Clause 19, the non-transitory computer-readable medium of any of clauses 1-18, further comprising applying a mathematical model to the objects to detect a license plate number, a vehicle identification number, a barcode, a QR code, information from a vehicle registration sticker, a part number, or partial part number, a service technician identifier, or any combination thereof.

Clause 20, the non-transitory computer-readable medium of any of clauses 1-19, further comprising: assigning a service order to the vehicle inspection, repair, and maintenance record, the service order including one or more service requests, parts list, service technician identifier, and customer information; assigning a shop identifier, such as, a watermark, a geotag, or both, that identifies an auto repair shop, date and time, and location to the vehicle inspection, repair, and maintenance record; and storing the service order and the shop identifier in the vehicle inspection, repair, and maintenance record.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

While various example embodiments of the present invention have been described above, it should be understood that they have been presented by way of example, and not limitation. It will be apparent to people skilled in the relevant art(s) that various changes in form and detail can be made therein. Thus, the present invention should not be limited by any of the above-described example embodiments but should be defined only in accordance with the following claims and their equivalents.

In addition, it should be understood that the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. An image processing system for identifying image objects and generating visualizations used for managing auto repair shop processes, comprising:
at least one storage device operable to store a vehicle inspection, repair, and maintenance log, images, and one or more mathematical models; and
a processor communicatively coupled to the storage device, the processor being operable to perform operations comprising:
applying a mathematical model to objects of an image to determine a pattern or predict a pattern that can be correlated to an identifier unique to an automobile, a component part thereof, or a service technician;
creating a vehicle inspection, repair, and maintenance record comprising the correlated pattern, unique identifier, the image, or any combination thereof;
storing the correlated pattern, unique identifier, the image, or any combination thereof in the vehicle inspection, repair, and maintenance record; and
generating a visualization comprising business intelligence, analytics, or both using at least a portion of the stored vehicle inspection, repair, and maintenance record.

2. The image processing system of claim 1, further comprising an object detection model for mobile accelerators.

3. The image processing system of claim 1, further comprising one or more sensing devices used to determine information unique to the automobile, the component part thereof, or the service technician.

4. The image processing system of claim 1, wherein the mathematical model comprises a parameter space trained using a dataset of generally related images, generally related objects, auto repair shop specific related images, auto repair shop specific related images, or any combination thereof, and automotive repair, maintenance, and management principles.

5. The image processing system of claim 4, wherein the mathematical model comprises a deep learning network or a convolutional neural network.

6. The image processing system claim 1, wherein the processor is further operable to perform operations comprising applying a mathematical model to the objects to detect a license plate number, a vehicle identification number, a barcode, a QR code, information from a vehicle registration sticker, a part number, or partial part number, a service technician identifier, or any combination thereof.

7. The image processing system of claim 1, wherein the processor is further operable to perform operations comprising:
assigning a service order to the vehicle inspection, repair, and maintenance record, the service order including one or more service requests, parts list, service technician identifier, and customer information;
assigning a shop identifier, such as, a watermark, a geotag, or both, that identifies an auto repair shop, date and time, and location to the vehicle inspection, repair, and maintenance record;
and storing the service order and the shop identifier in the vehicle inspection, repair, and maintenance record.

8. A method of image processing to generate visualizations used for managing auto repair shop processes, comprising:
by one or more computing devices:
storing a vehicle inspection, repair, and maintenance log, images, and one or more mathematical models;
applying a mathematical model to objects of an image to determine a pattern or predict a pattern that can be correlated to an identifier unique to an automobile, a component part thereof, or a service technician;
creating a vehicle inspection, repair, and maintenance record comprising the correlated pattern, unique identifier, the image, or any combination thereof;
storing the correlated pattern, unique identifier, the image, or any combination thereof in the vehicle inspection, repair, and maintenance record; and
generating a visualization comprising business intelligence, analytics, or both using at least a portion of the stored vehicle inspection, repair, and maintenance record.

9. The method of claim 8, wherein the mathematical model comprises a parameter space trained using a dataset of generally related images, generally related objects, auto repair shop specific related images, auto repair shop specific related images, or any combination thereof, and automotive repair, maintenance, and management principles.

10. The method of claim 9, wherein the mathematical model comprises a deep learning network or a convolutional neural network.

11. The method of claim 10, further comprising applying a mathematical model to an image to detect a license plate number, a vehicle identification number, information from a barcode, information from a QR code, information from a vehicle registration sticker, a part number, or partial part number, a service technician identifier, or any combination thereof.

12. The method of claim 8, further comprising sensing encoded data and correlating the encoded data to identification information associated with the automobile, the component part thereof, or the service technician.

13. The method of claim 8, further comprising:
assigning a service order to the vehicle inspection, repair, and maintenance record, the service order including one or more service requests, parts list, service technician identifier, and customer information;
assigning a shop identifier, such as, a watermark, a geotag, or both, that identifies an auto repair shop, date and time, and location to the vehicle inspection, repair, and maintenance record; and
storing the service order and the shop identifier in the vehicle inspection, repair, and maintenance record.

14. A non-transitory computer-readable medium storing instructions that, when executed by one or more computing devices, cause the one or more computing devices to perform operations, the operations comprising:
storing a vehicle inspection, repair, and maintenance log, images, and one or more mathematical models;
applying a mathematical model to objects of an image to determine a pattern or predict a pattern that can be correlated to an identifier unique to an automobile, a component part thereof, or a service technician;
creating a vehicle inspection, repair, and maintenance record comprising the correlated pattern, unique identifier, the digital image, or any combination thereof;
storing the correlated pattern, unique identifier, the digital image, or any combination thereof in the vehicle inspection, repair, and maintenance record; and
generating a visualization comprising business intelligence, analytics, or both using at least a portion of the stored vehicle inspection, repair, and maintenance record.

15. The non-transitory computer-readable medium of claim 14, wherein the mathematical model comprises an object detection model for mobile accelerators.

16. The non-transitory computer-readable medium of claim 14, further comprising sensing encoded data and correlating the encoded data to identification information associated with the automobile, the component part thereof, or the service technician.

17. The non-transitory computer-readable medium of claim 14, further comprising training the mathematical model using a dataset of generally related images, generally related objects, auto repair shop specific related images, auto repair shop specific related images, or any combination thereof, and automotive repair, maintenance, and management principles.

18. The non-transitory computer-readable medium of claim 17, wherein the mathematical model comprises a deep learning network or a convolutional neural network.

19. The non-transitory computer-readable medium of claim 14, further comprising applying a mathematical model to the objects to detect a license plate number, a vehicle identification number, a barcode, a QR code, information from a vehicle registration sticker, a part number, or partial part number, a service technician identifier, or any combination thereof.

20. The non-transitory computer-readable medium of claim 14, further comprising:
assigning a service order to the vehicle inspection, repair, and maintenance record, the service order including one or more service requests, parts list, service technician identifier, and customer information;
assigning a shop identifier, such as, a watermark, a geotag, or both, that identifies an auto repair shop, date and time, and location to the vehicle inspection, repair, and maintenance record; and
storing the service order and the shop identifier in the vehicle inspection, repair, and maintenance record.
